(19) United States
(12) Patent Application Publication
(10) Pub. No.: US 2021/0380051 A1
(43) Pub. Date: Dec. 9, 2021

(54) Recreational Vehicle Wastewater Holding Tank By-Pass and Flush Piping Apparatus

(71) Applicants: Wayne Stanley Taylor, Essex (CA); Janet Mary Taylor, Essex (CA)

(72) Inventors: Wayne Stanley Taylor, Essex (CA); Janet Mary Taylor, Essex (CA)

(21) Appl. No.: 17/184,658

(22) Filed: Feb. 25, 2021

Related U.S. Application Data
(63) Continuation-in-part of application No. 16/895,470, filed on Jun. 8, 2020, now abandoned.

(51) Int. Cl. B60R 15/04; B60R 15/02; E03F 1/00

(52) U.S. Cl. CPC B60R 15/04; E03F 1/008; B60R 15/02

(57) ABSTRACT

The Recreational Vehicle (RV) Black Water Holding Tank By-Pass Piping Apparatus invention is a RV black water holding tank by-pass plumbing system that enables continuous use of the toilets within said RV while docked that is residential plumbing code compliant. Our invention consists of additional “Drain” piping , fittings and gate valves to divert the toilets discharge waste product when flushed around the RV's existing Black Water Holding/Storage Tank directly to the RV's Main Sewer Connection while at the same time maintaining the ability to flush the entire sewer discharge piping/lines with available waste from the RV's gray water storage/holding tanks as highly recommended by all RV manufacturers. This by-pass capability eliminates the need to “Routinely Dump” the normally accumulated black wastewater collected in the black water tank, a procedure that can be required typically every 3 to 5 days and one that can also, by the nature of the waste product being handled, cause severe illness if not performed with caution. Our invention does not require any replacement or reworking of any Original Equipment (RV) Manufacturer's (OEM) provided appliances or apparatus. All required components are external to these devices. Our invention can either be installed as part of the original build at the RV manufacturers manufacturing facility or as an add on or “After Market” addition at any Dealers or RV Equipment Suppliers facility/shop. While our inventions description describes a primarily manually operated system it can optionally include a partially automated wired or wireless automation control system. This invention minimizes the environmental impact of the use of black wastewater holding tank additives/chemicals by avoiding use of the black wastewater holding tank entirely thereby enabling the conservation of chemical additives commonly used by preventing the need to add them.

### TECHNICAL FIELD OF THE INVENTION

The present invention relates generally to a plumbing system for a recreational vehicle. The present invention relates generally to a By-Pass plumbing system for the black water holding tank system(s) of a recreational vehicle.

The present invention relates specifically to a by-pass plumbing system for a recreational vehicle to enable a docking connection for the continuous use of the toilet(s)-while the recreational vehicle is parked.

The present invention relates specifically to a by-pass plumbing system for the black water holding tank systems of a recreational vehicle to re-route the waste/sewage from the toilet(s) to an exterior drain thereby enabling the continuous use of toilets-conserving on the chemical additives normally required within the Holding Tank to assist with the breakdown of the waste solids and paper, by essentially By-Passing the black water holding tank(s) for storage and disposal of liquid waste/sewage.

### BACKGROUND OF THE INVENTION

Todays typical black and grey water tanks in recreational vehicles [RV] sewer hookups incorporate fresh, black and grey water holding tank systems to capture and hold drained fluids and particulate until a dump station can be accessed. The dump station/connection can be on the site at a specific location in and around an RV Park or at a Travel Center. The connection from the RV main discharge to sewer shut off valve is typically made utilizing commercially available flexible sewer hose kits. These various types of situations with respect to the RV site itself are often described as full service, partial service, and no sewer type locations.

The fresh water system is exactly that. A holding tank that can be filled with potable/drinkable water for use throughout the RV for all occasions where water is required. The black water system refers to that water system where human excretion is present and requires special attention and care to avoid possible sickness. The grey water system is often systems fed with clean “fresh” water but is then made un-reusable by the nature of its use, typically in an RV from wash basin, shower, washing machine, and any other connected drains.

The water systems in any given RV will vary in capacity and efficiency with each type of RV in which they are utilized. Most RV owners choose this lifestyle for its flexibility and versatility. The water systems are the biggest limiting features on an RV in providing the RV freedom we all strive for.

The black water system is the biggest culprit, in contributing to these limitations. Because of the nature of the affluent being stored/handled it is the most time consuming when it comes to daily/weekly maintenance and care. Special attention to chemical additives that assist in breaking down solids and ensuring that only “RV” designed toilet paper is flushed into these systems elevates the attention and care it requires. Different factors such as black tank storage capacity and grey water for flushing recommendations, tend to impose restrictions on the freedom aspect of this type of travel.

That being said, those RV'ers who have hauled and traveled for extended periods of time have no doubt experienced some of the repetitive trends in these systems as well as the disasters which can/will occur if the proper attention is not given to their use/operation/dumping and cleaning. It only takes one bad occurrence for each person involved and very quickly we develop special routines as to their maintenance and care.

Most RV manufacturers standard operating procedures will direct the owners to keep all tank dump values closed until such time as the respective tanks become a minimum of three-quarters full as indicated on the RV's operating/control panel, and that these valves be closed again after dumping, which also includes the main dump valve so as not to allow gases to back up into the RV from the sites sewer system. Seasoned RV'ers have gained enough operational experience to know that in some cases, provided special means are employed to prevent gas backup, that they can get by cautiously, with leaving the grey valve[s] open, thereby eliminating some of the repetitive scheduled dumping of these system.

All RV'ers must take care to remember and plan that at least one grey tank be allowed to fill as it is strongly recommended that at least one tank be used as a discharge hose rinse after the black tank has been drained. The more experienced owners have also found out how to create a temporary form of a p-trap just after the main dump valve to help prevent gas backup into the RV while the grey valves are open. Temporary forms of a p-trap are created by positioning the flexible sewer hose into a p-trap configuration with the addition of temporary supports under and on the sides of the flexible hose such that it will maintain the p-trap shape during use.

Most RV manufacturers remind all RV'ers to keep a check list and review it daily with respect to dumping frequencies of the various systems, and to be disciplined in this habit.

The one thing that has not changed and that is still a bit of a thorn-in-the-sides of RV'ers is the dumping of the black and grey water holding tanks. It is one part of the lifestyle that is commonly considered a drawback. With respect to the latest developments in the art of the RV's Black Water systems today, it has been become more commons amongst the OEM's since approximately 2011-12 is to incorporate a black water tank rinse system as part of their supply, however even this improvement, has not overcome the time consuming, repetitive, potentially unhealthy and unpleasant nature of the dumping task.

Thus it is clear that there is a need for systems that alleviate RV'ers consternations, difficulties, and unpleasantries associated with the dumping of the RV's black water tank and piping systems. There is a need for a process/system that can enable the continuous use of the toilet[s] without using the black water holding tanks.

### BREIEF DESCRIPTION OF THE INVENTION

The apparatus of the present invention focuses on the following issues that dramatically improving the dumping process, specifically; [1] a black water holding tank by-pass for parked or docked [sewer utility connected] RV's that would allow for a continuous black water disposal process that is compliant with residential plumbing construction code including, but not limited to, piping venting, a Main sewer connected “P-Trap”, backflow [2] preventors by eliminating the use of the holding tank while the system is in By-OPass, we reduce the need to add black tank chemical agents that assists in breaking down the solids present in the black water, and as required/recommended by the manufacturer thereby reducing cost and the chemicals potential environmental impact, [3] reduces potential “Black Water Tank” cleaning/repair/replacement due to accumulated build up of sediment/solids in the tank over time of repetitive use.

We have invented a recreational vehicle black water holding tank by-pass apparatus which allows for a continuous use sewer connection of a recreational vehicle comprising a plurality of manually operated gate valves and by-pass piping attached to the RV's main sewer pipe connection. This invention will eliminate the need for the repetitive emptying of the black water tank and cleaning tasks associated with this distasteful task.

The invention further comprises the addition of wired and/or wireless automated controls connectively attached for automated operational control of the present invention.

By using this invention's toilet to a black water tank by-pass apparatus to by-pass the use of said black water tank we are conserving on the use of black water tank additives by by-passing the use of said black water tank thereby preventing a need to add additives.

An advantage of the present invention is that it enables the continuous use of the toilet without using the black water holding tank of a parked/docked recreational vehicle, conserving the use of the black and grey water holding tanks and reduces potential “Black Water Tank” cleaning/repair/replacement due to accumulated buildup of sediment/solids in the tank over time of repetitive use.

### BREIF DESCRIPTION OF THE FIGURES

FIG. 1 shows an overall conceptual view of the functioning relationships of the waste water systems as they are typically provided by the Original Equipment Manufacturer [OEM] at time of purchase.

FIG. 2 shows an overall conceptual view of the functioning relationships of the ADDED black water tank by-pass system components of the present invention to the waste water systems as they are typically provided by the Original Equipment Manufacturer [OEM] at time of purchase.

FIG. 3 shows the location of the invention within a typical plumbing system of an RV.

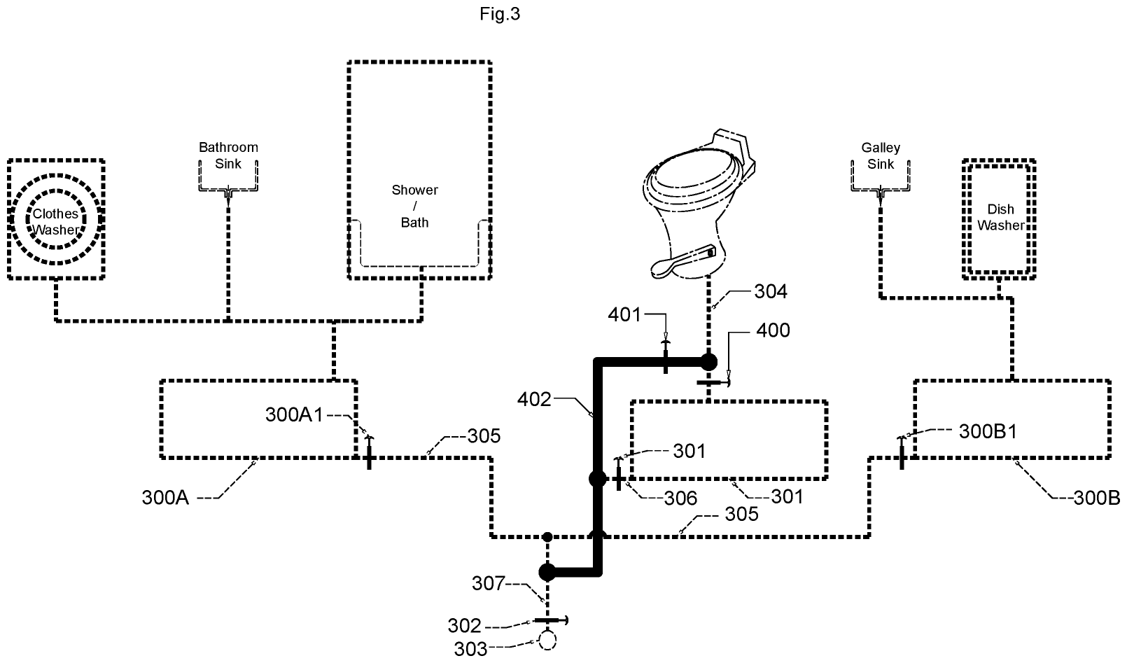

### DETAILED DESCRIPTION

The detailed embodiments of the present invention are disclosed herein. The disclosed embodiments are merely exemplary of the invention, which may be embodied in various forms.

The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions [e.g., “above,” “below,” “up,” “left,” “right,” “down,” “top,” “bottom,” “vertical,” “horizontal,” etc.] used herein are for purposes of illustration only, and that practical implementations of the structures described herein can be spatially arranged in various orientations or manners.

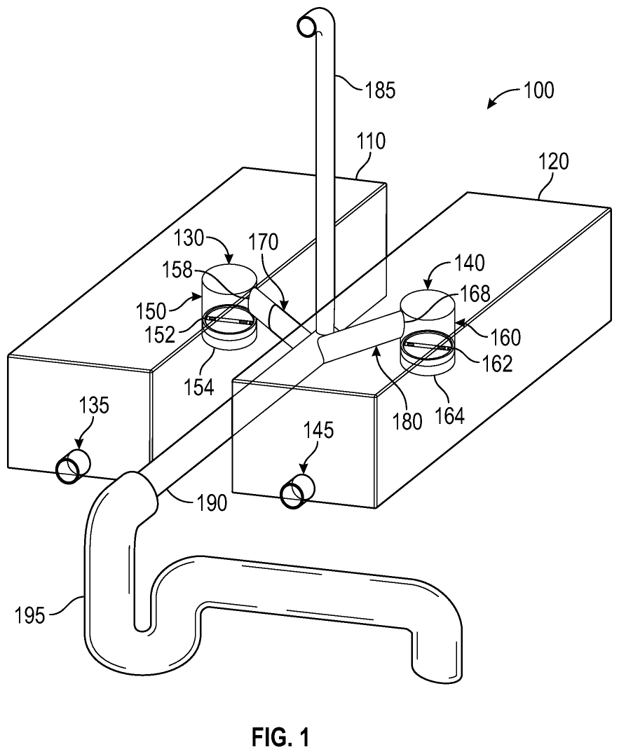

Referring to the figures, that are shown in FIG. 1, entitled, the following list of elements (in numeric order):

Element 100A is a gray water waste holding tank 1

Element 100A1 is the gray water waste holding tank 1 discharge gate valve

Element 100B is a gray water waste holding tank 2

Element 100B1 is the gray water waste holding tank 2 discharge gate valve

Element 101 is a black water waste holding tank

Element 1011 is the black water waste holding tank discharge gate valve

Element 102 is the RV main discharge connection to sewer gate valve

Element 103 is the RV main discharge to sewer connection point on the RV

Element 104 is the main discharge pipe from the toilets bottom discharge to the black water waste holding tank in the “As provided by the OEM” scenario and to the black water tank inlet shut off valve 201 AND the black water tank by-pass valve 202 in the “By-Pass” scenario

Element 106 is the main discharge pipe from the black water waste holding tank discharge gate valve 1011 to the RV main discharge pipe 107 connection

Element 107 is the main discharge pipe from the connection point of the main discharge pipe from the gray tank(s) discharge valves 100A1 AND 100B1-105, the main discharge pipe from the black water waste holding tank discharge gate valve 1011-106 in the in the “As provided by the OEM” scenario and as well as the main discharge by-pass pipe from the black water tank by-pass pipe 203 in the “By-Pass” scenario.

In Todays scenario where a “Blackwater Tank By-Pass” is not installed on the RV or if there has been a system installed and the owner is not utilizing the by-pass option and has preferred to send the Black Water waste direct to its respective storage tank. NOTE: Most manufacturers will specify in their instructions that while the RV is traveling or not being used or the tanks are not at least ¾ full, that “ALL WASTE WATER VALVES BE CLOSED/SHUT/TURNED OFF”. The following set up instructions assume this state when the RV first arrives at a location or point of use and that the required sewer hose from the RV to the Site sewer Connection/Dump Station is installed and operational.

to Dump the Gray Water tank(s)

.1 open the RV main discharge connection to sewer gate valve 102

.2 open the the gray water waste holding tank discharge gate valve. If there is more than one gray water holding tank Empty only ONE TANK AT A TIME as two tanks being emptied simultaneously may exceed the discharge sewer lines volume capabilities and cause a potential issue.

.3 when you are satisfied that the tank has emptied close the respective tanks waste holding tank discharge gate valve.

.4 when you are satisfied that as much of the waste water being dumped has emptied the sewer lines close the RV main discharge connection to sewer gate valve 102.

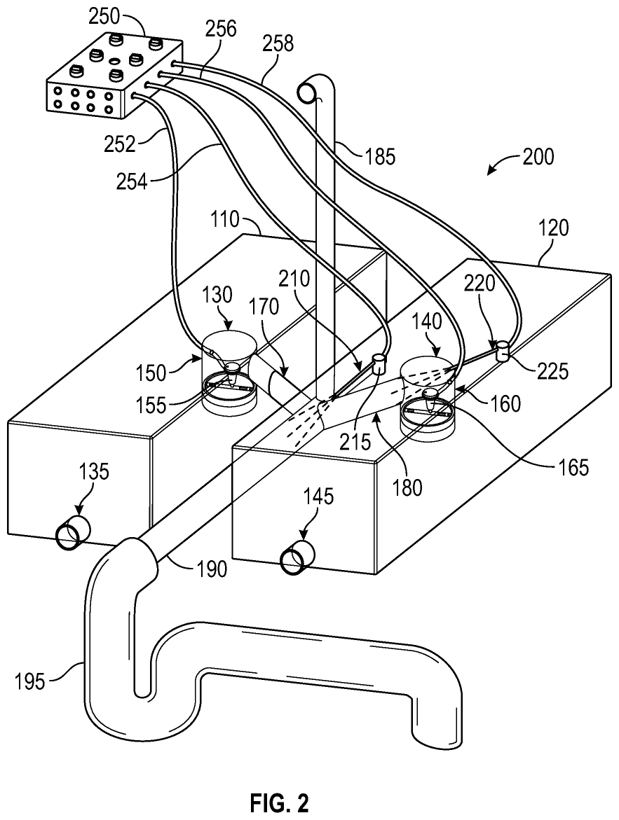

Referring to the figures, that are shown in FIG. 2 the following list of elements (in numeric order)

Element 201 the black water tank inlet shut off valve

Element 202 the black water tank by-pass valve

Element 203 is the main discharge by-pass pipe from the black water tank by-pass valve 202 to the connection point to pipe 107

In a scenario where a “Blackwater Tank By-Pass” is installed on the RV and the owner wants to utilize the by-pass option:

.1—open the RV main discharge connection to sewer gate valve 102

.2—ensure that the black water waste holding tank discharge gate valve 1011 is closed

.3—close the black water tank inlet shut off valve 201

.4—open the black water tank by-pass valve 202

.5—when you are ready to leave the site or wish to switch back to sending the black water waste to the black water holding/storage tank close the the black water tank by-pass valve 202

.6—open the black water tank inlet shut off valve 201

.7—ensure that the black water waste holding tank discharge gate valve 1011 is closed

.8—close the black water tank by-pass valve 202

The components of the apparatus of the present invention is for by-passing the black tank starting with the by-pass valve 202 the by-pass valve 202 the by-pass valve 202 situated in the pipe 203 from the toilet bottom discharge to the black water pipe 104 to the black tank entry hole. The by-pass valve 202 that the black water waste stream from a connected drain point toilet-to an alternate drainage exit via pipe 203.

The grey water holding tank by-pass drain pipe105 and the black water holding tank by-pass drain pipe 103 and pipe 107 are pitched with the proper sewer drainage pitch connectively attached for sewage with the proper pipe pitch for sewer drainage. The conventional or usual proper plumbing pitch for sewage draining piping is typically 0.635 cm (0.25 inch) drop over a 30.48 cm (12 inch) run. The apparatus of the present invention can be embodied with any plumbing pitch known to function properly by ensuring the continuous flow of effluent. The various by-pass valves, are manually operable without said automated controls. The various by-pass valves, when connectively attached to automation controls are manually operable without said automated controls for emergency and power outage control of said by-pass valves.

The preferred embodiment the apparatus of the present invention can further comprise a control panel [250] with an automatic switching system to enable or disable the by-passing and water flushing devices/elements of the present invention in partially or fully automated operation.

In an embodiment a plurality of on/off automation controls on the control panel 250 connectively attach to each component/element to automate the system are added.

This Optional automated controls include electrical, pneumatic, and/or mechanical controls and wring from each control connectively attached to each element of the system back to a set of collectively centralized electrical and/or mechanical controls on a control panel that enable the automatic operation of each and all of the elements of the apparatus of the present invention to partially or fully automate its operation.

The present invention reduces the use of RV black tank chemicals and/or additives when in by-pass operation given that the tank is completely by-passed and therefore does not require the additives. This reduction in the use of black tank chemicals contributes to lower cost operation, and reduction in environmental impact. The present invention reduces the use of the black water tank of an RV and consequently reduces the normal buildup of detritus that passes through, less buildup of detritus results in easier and more complete flushing and cleaning.

In a preferred embodiment, there is a recreational vehicle (RV) toilet to black water tank by-pass apparatus comprising a by-pass valve having an open position and a closed position, a waste water entry, a open valve exit connectively attached to said RV black water holding tank, and a closed valve exit connectively attached to a pipe having a vent and a p-trap enabling the continuous by-pass of the black water tank enabling continuous use of said RV toilet while conserving the use of said black water tank.

In an alternate embodiment, there is a RV toilet to black water tank by-pass apparatus further comprising a plurality of automated controls connectively attached to said by-pass valve enabling the automated control of said by-pass.

In an alternate embodiment, there is a method of using a toilet to a black water tank by-pass apparatus to by-pass the use of said black water tank to conserve use of black water tank additives by by-passing the use of said black water tank thereby preventing a need to add additives.

A key advantage of the apparatus/device of the present invention is that once it is installed in a recreational vehicle it enables the continuous use of the toilet without using the black water holding tanks.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A recreational vehicle (RV) toilet to black water tank by-pass process/piping system comprising a by-pass valve having an open position and a closed position, a waste water entry, an open valve exit connectively attached to said RV black water holding tank, and a closed valve exit connectively attached to a by-pass pipe enabling the continuous by-pass of the black water effluent around the manufacturers typically provided black water tank enabling continuous use of said RV toilet while conserving the use of said black water tank.

2. The apparatus of claim 1 further comprising a plurality of selective automated controls connectively attached to said by-pass valve enabling the automated control of said by-pass.

3. A method of using a toilet to a black water tank by-pass apparatus to by-pass the use of said black water tank to conserve use of black water tank additives by by-passing the use of said black water tank thereby preventing a need to add additives.

13. A method of using RV toilet to black water tank by-pass apparatus to by-pass the use of said black water tank. In doing so we reduce/eliminate the use of said black water tank thereby preventing a need to add the additives. In addition to the cost and time savings associated with this requirement we also add the the environmental friendliness of the RV experience.
